(19) United States
(12) Patent Application Publication
(10) Pub. No.: US 2026/0017669 A1
(43) Pub. Date: Jan. 15, 2026

(54) SYSTEM AND METHOD FOR IMPROVING CUSTOMER ENGAGEMENT

(71) Applicant: DevRev, Inc., Palo Alto, CA (US)

(72) Inventors: Dhruv Baldwa, Bengaluru (IN); Nikhil Talwar, Bengaluru (IN)

(73) Assignee: DevRev, Inc., Palo Alto, CA (US)

(21) Appl. No.: 19/094,778

(22) Filed: Mar. 28, 2025

(30) Foreign Application Priority Data
Jul. 12, 2024 (IN) 202441053526

(51) Int. Cl. G06Q 30/016; G06F 11/362; G06Q 10/20

(52) U.S. Cl. CPC G06Q 30/016; G06F 11/362; G06Q 10/20

(57) ABSTRACT

A customer support system for improving engagement as a customer navigates a software product is provided. The customer support system includes a session recording module configured to capture a screen recording of a customer session. It further includes a session analysis module coupled to the session recording module and configured to analyse the screen recoding to generate a corresponding summary of the customer session and to tag a plurality of issues faced by the customer during the customer session. The customer support system further includes a suggestion module configured to provide a plurality of suggestions in real-time to the customer.

### RELATED APPLICATION DATA

This application claims priority to, and the benefit of Indian Patent Application number 202441053526 filed on Jul. 12, 2024. The entire disclosure of the above application is expressly incorporated by reference herein.

### BACKGROUND

The invention generally relates to the field of customer support systems and more particularly, to a system and method for improving customer engagement.

Various organisations, to deliver uninterrupted service towards achieving business efficiency, employ various systems to assist customers and improve customer engagement. It is therefore important to gain a better understanding of the issues faced by customers as this results in providing effective and timely assistance.

Traditional text-based chat support systems often fall short in capturing the complete context of a customer's problem. Customers may often struggle to articulate the nature of technical issues they encounter, leading to miscommunication and extended resolution times. This gap in understanding often result in frustration and reduced satisfaction, which ultimately leads to customer churn.

Current solutions for capturing customer issues typically involve extensive back-and-forth communication between a customer support team and the customer. Customers are often required to describe their problem in detail or provide screenshots, which may not fully capture the sequence of actions that led to the issue. This process is not only cumbersome and time-consuming for the user but also places a significant burden on support teams to interpret and diagnose the problem accurately from incomplete information.

In addition, a significant number of customers do not reach out for support even when encountered with issues. It is often noticed that the tasks are abandoned midway or the customer exits the platform, leading to reduced engagement and satisfaction. Existing systems lack the capability to detect when customers are stuck and proactively offer help, resulting in missed opportunities to improve user experience and product utilization. Further, customer support agents usually are loaded with information from multiple sources from a single user and navigating through large amounts of data results in longer time for resolution.

Therefore, there is a need for a customer support system that can proactively provide suggestion to customers while navigating and product and provide accurate contextual information to customer support team to resolves issues faced by the customer(s).

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a customer support system for improving engagement as a customer navigates a software product is provided. The customer support system includes a session recording module configured to capture a screen recording of a customer session. It further includes a session analysis module coupled to the session recording module and configured to analyse the screen recoding to generate a corresponding summary of the customer session and to tag a plurality of issues faced by the customer during the customer session. The customer support system further includes a suggestion module configured to provide a plurality of suggestions in real-time to the customer.

In another embodiment, a method for improving customer engagement as a customer navigates a software product is provided. The method comprises capturing a screen recording of a customer session, analysing the screen recording to generate a corresponding summary of the customer session and tagging a plurality of issues faced by the customer during the customer session. The method further includes providing a plurality of suggestions in real-time to the customer while the customer explores a plurality of features of the software product.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of an embodiment of a customer support system for improving customer engagement, implemented according to aspects of the present technique;

FIG. 2 is a flow chart describing one method for ticket resolution, implemented according to aspects of the present technique;

FIG. 3 and FIG. 4 are examples of a user interface implemented according to aspects of the present technique; and

FIG. 5 is a block diagram of an embodiment of a computing device in which the modules of the customer support system described herein are implemented.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

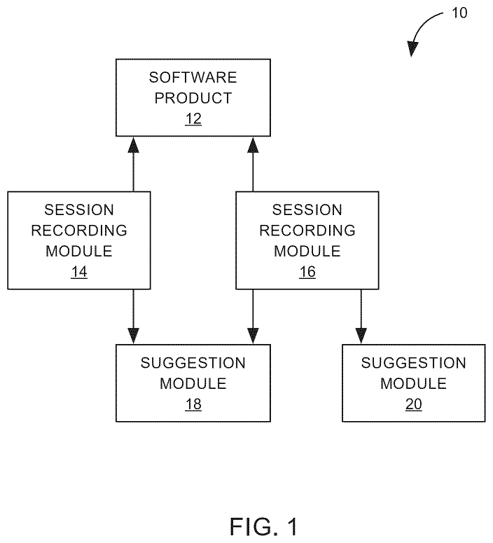

Example embodiments of the present invention provide systems and methods for improving customer engagement. FIG. 1 is a block diagram of an embodiment of a customer support system implemented according to aspects of the present technique. Customer support system 10 is configured to improve engagement as a customer navigates a software product 12. Customer support system 10 comprises a session recording module 14, session analysis module 16, suggestion module 18 and ticket module 20. Each block is described in further detail below.

Session recording module 14 is configured to capture a screen recording of a customer session. As used herein, customer session refers to a period from when customer begins interaction with the product till such time the customer ends the interaction or the customer initiates a ticket with a customer support team. In one embodiment, the session recording includes various actions performed by the customer's actions, including clicks, page navigations, form entries, and any error messages encountered. In a further embodiment, the session recording module is further configured to mask the customer's data and information.

Session analysis module 16 is coupled to the session recording module and is configured to analyse the customer session and to generate a corresponding summary of the screen recording. The session analysis module is further configured to tag a plurality of issues faced by the customer during the customer session.

Session analysis module is further configured to maintain a session log. In one embodiment, the session log comprises one or more errors and glitches encountered by the customer during the customer session. Further, one or more critical items in the session log is highlighted for priority resolution by a customer support team.

Suggestion module 18 is coupled to session analysis module and is configured to provide a plurality of suggestions in real-time to the customer while the customer explores a plurality of features of the software product. In addition, the suggestion module is configured to dynamically update the plurality of suggestions based on a plurality of insights. The plurality of insights are determined by continuously identifying user behaviour patterns, such as repeated actions, time spent on specific tasks, and error occurrences across hundreds of customer sessions available to the system. In one embodiment, the suggestion module is configured to detect instances when the user is unable to proceed. Upon detecting potential customer difficulties, the suggestion module is configured to generate proactive suggestion to assist the customer to move forward quickly. In one embodiment, the suggestions are personalized based on the context of the customer's actions.

Ticket module 20 is configured to generate tickets when a customer encounters an issue with the product. The ticket module is configured to enable a customer support team to resolve one or more tickets raised by the customer during or after the customer session. In one embodiment, the summary of the customer session is attached to the ticket when the customer raises a ticket. Further, the ticket module is configured to access the session log for providing context to the customer support team. The manner in which the customer support system provides assistance to the customer support team is described in further detail below.

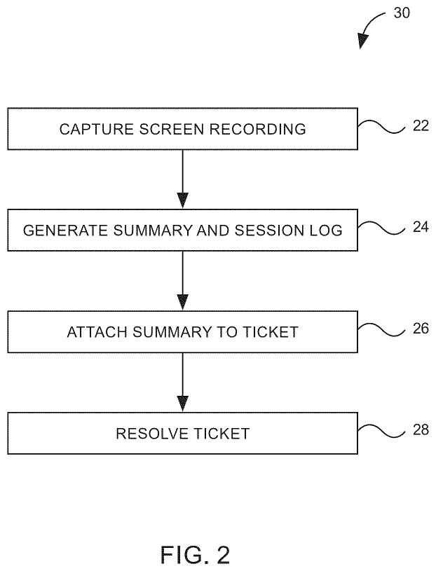

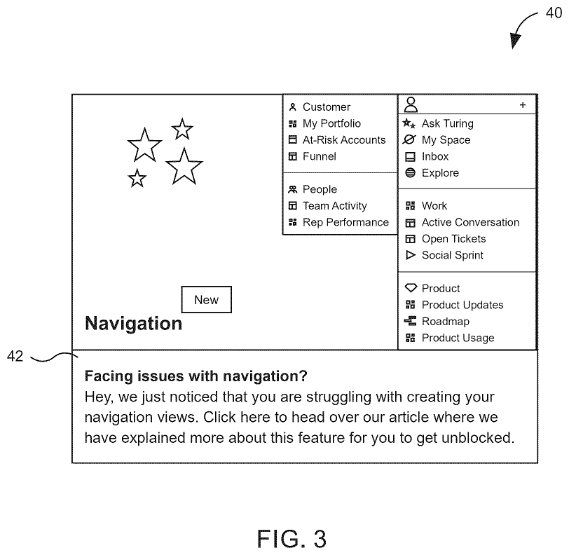

FIG. 2 is a flow chart illustrating one method by which the customer support system improves engagement with the customer. As used herein, a customer session refers to a period where a customer is actively engaged with a product. Each step of the method is described in further detail below.

At step 22, a screen recording of a customer session is captured. As used herein, the screen recording captures a journey of the customer as they navigate the different features of the product.

At step 24, the screen recording of the customer session is analysed to generate a corresponding summary of the customer session. In one embodiment, key frames are identified from the screen recording and the summary is derived from the identified key frames. In addition, the screen recording is analysed to also tag a plurality of issues faced by the customer during the customer session. Further the screen recording is used to identify a plurality of potential bugs in the product. The bugs may then be flagged to be addressed by a product team for improving features of the product.

In one embodiment, a session log is maintained where errors and/or glitches encountered by the customer during the customer session are recorded. In a further embodiment, one or more critical items in the session log is highlighted for priority resolution by a customer support team.

At step 26, the summary of the screen recording is attached to a ticket that is raised by the customer. It may be noted that the ticket may be raised by the customer during or after the customer session. When a customer raises a ticket, the corresponding screen recording is identified and the summary of the customer session is attached to the ticket to provide context to a customer support team. This, in turn, results to efficient and effective resolution of the ticket raised by the customer as indicated in step 28.

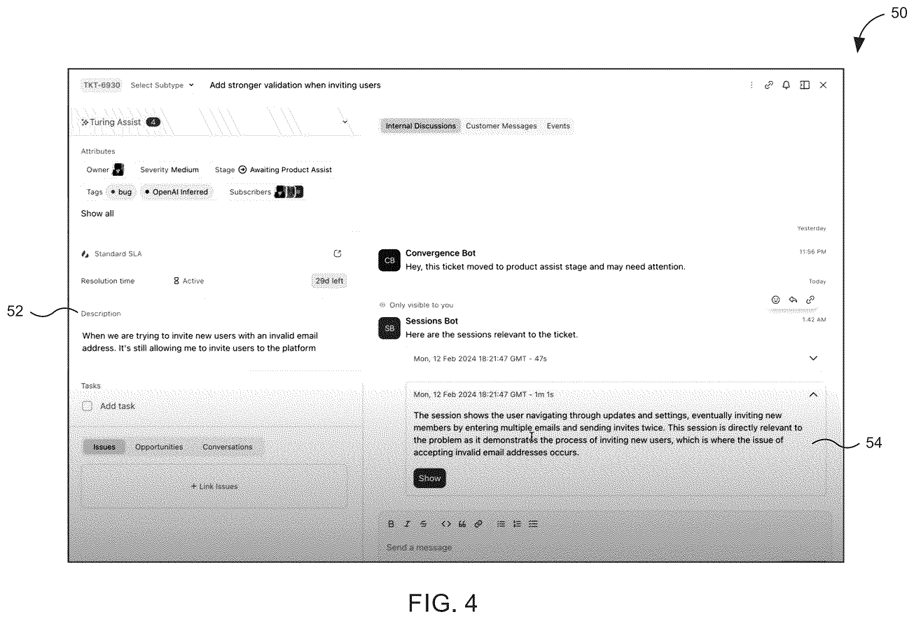

As described above, the customer support system 10 is configured to improved customer engagement by proactively providing suggestions to the customer while browsing through the product. An example user interface 40 is shown in FIG. 4 where a customer is seemingly stuck while browsing drop down menus with multiple features. Suggestion 42 indicates to potential solutions to enable the customer to navigate through the potential problem. In one embodiment, suggestion 42 appears as note as shown. Other ways suggestion 42 appears to the customer may be in the form of pop-up boxes, audio clippings, banners, modals, videos and interactive journeys, etc.

FIG. 4 is an example customer support interface 50 implemented according to aspects of the present technique. A customer while using the product encounters a specific problem raises a ticket 52 which includes a description of the problem. The customer support system described herein generates a summary 54 of the corresponding customer session and attaches it to the ticket as show. Summary 54 provides context to the customer support team for fast and effective resolution of the problem. In one embodiment, the customer support team can also view the customer session, API calls, console logs and core web vitals and the like.

The above described invention provides several advantages including providing relevant context to customer support teams thus enabling accurate and faster resolution of problems faced by the customers. This leads to improved support metrics such as time to resolution, customer satisfaction, customer experience and customer engagement. The proactive suggestions offered to the customer while navigating the product enhances customer experience which eventually help in retaining customer base.

The various actions, acts, blocks, steps, or the like as described above may be performed in the order presented, in a different order or simultaneously. Further, in some embodiments, some of the actions, acts, blocks, steps, or the like may be omitted, added, modified, skipped, or the like without departing from the scope of the invention.

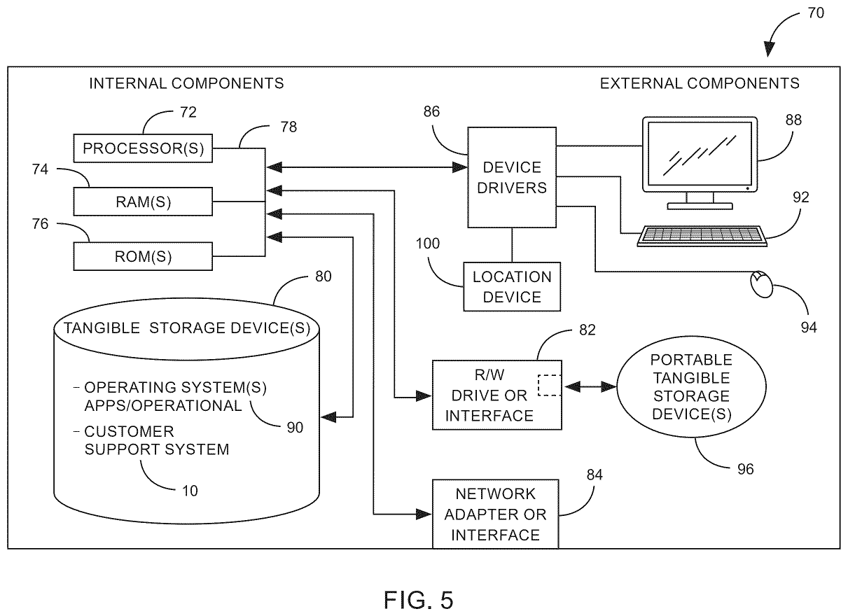

The customer support system described herein is implemented using a computing device such as computing device 70 is described below in FIG. 5. The computing device 70 includes one or more processor(s) 72, one or more computer-readable RAMs 74 and one or more computer-readable ROMs 76 on one or more buses 78. Further, computing device 70 includes a tangible storage device 80 that may include customer support system 10 for improving engagement with customers. The various modules of the system 10 may be stored in the tangible storage device 80. Both, the operating systems 90 and the system 10 are executed by the one or more processor(s) 72 via one or more respective RAMs 74 (which typically include cache memory). The execution of the operating systems 90 and/or the system 10 by the one or more processor(s) configures the one or more processor(s) as a special purpose processor configured to carry out the functionalities of the operation systems) and/or the system 10 as described above.

Examples of the tangible storage device include semiconductor storage devices such as ROM, EPROM, flash memory or any other computer-readable tangible storage device that may store a computer program and digital information.

Computing device 70 also includes a R/W drive or interface 82 to read from and write to one or more portable computer-readable tangible storage devices 96 such as a CD-ROM, DVD, memory stick or semiconductor storage device. Further, network adapters or interfaces 84 such as a TCP/IP adapter cards, wireless Wi-Fi interface cards, or 3G or 4G wireless interface cards or other wired or wireless communication links are also included in computing device.

In one example embodiment, the customer support system 10 may be stored in the tangible storage device and may be downloaded from an external computer via a network (for example, the Internet, a local area network or other, wide area network) and network adapter or interface.

Computing device 70 further includes device drivers 86 to interface with input and output devices. The input and output devices may include a computer display monitor 88, a keyboard 92, a keypad, a touch screen, a computer mouse 94, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

1. A customer support system for improving engagement as a customer navigates a software product, the customer support system comprising:
a session recording module configured to capture a screen recording of a customer session;
a session analysis module coupled to the session recording module and configured to:
analyze the screen recoding to generate a corresponding summary of the customer session;
tag a plurality of issues faced by the customer during the customer session;
a suggestion module configured to provide a plurality of suggestions in real-time to the customer while the customer explores a plurality of features of the software product.

2. The customer support system of claim 1, wherein the session analysis module is configured to maintain a session log; wherein the session log comprises one or more errors and glitches encountered by the customer during the customer session.

3. The customer support system of claim 2, wherein the session analysis module is further configured to highlight one or more critical items in the session log for priority resolution by a customer support team.

4. The customer support system of claim 2; further comprising a ticket module configured to enable a customer support team to resolve one or more tickets raised by the customer during or after the customer session; wherein the ticket module is configured to access the session log for providing context to the customer support team.

5. The customer support system of claim 2, wherein the ticket module is further configured to access the summary of the customer session.

6. The customer support system of claim 2, wherein the sessions analysis module is further configured to identify a plurality of potential bugs in the product based on the customer session; wherein the plurality of bugs is flagged to the customer support team for resolution.

7. The customer support system of claim 1, wherein the suggestion module is configured to dynamically update the plurality of suggestions based on a plurality of insights.

8. The customer support system of claim 7; wherein the plurality of suggestions is personalized to the customer.

9. A method for improving customer engagement as a customer navigates a software product, the method comprising:
capturing a screen recording of a customer session;
analyzing the screen recording to generate a corresponding summary of the customer session;
tagging a plurality of issues faced by the customer during the customer session;
providing a plurality of suggestions in real-time to the customer while the customer explores a plurality of features of the software product.

10. The method of claim 9, further comprising maintaining a session log; wherein the session log comprises one or more errors and glitches encountered by the customer during the customer session.

11. The method of claim 10, further comprising highlighting one or more critical items in the session log for priority resolution by a customer support team.

12. The method of claim 11; further comprising enabling a customer support team to resolve one or more tickets raised by the customer during or after the customer session.

13. The method of claim 12, further comprising enabling access the summary of the customer session to provide context to the customer support team.

14. The method of claim 12, further comprising identifying a plurality of potential bugs in the product based on the customer session; wherein the plurality of bugs is flagged to the customer support team for resolution.

15. The method of claim 9, further comprising dynamically updating the plurality of suggestions based on a plurality of insights and personalizing the plurality of suggestions based on the customer.
